(19) United States
(12) Patent Application Publication
(10) Pub. No.: US 2023/0080120 A1
(43) Pub. Date: Mar. 16, 2023

(54) MONOCULAR DEPTH ESTIMATION DEVICE AND DEPTH ESTIMATION METHOD

(71) Applicants: SK hynix Inc., Icheon (KR); Korea Advanced Institute of Science and Technology, Daejeon (KR)

(72) Inventors: Saad Imran, Seoul (KR); Muhammad Umar Khan, London (GB); Sikander Bin Mukaram, Nortwood (GB); Chong-Min Kyung, Daejeon (KR)

(21) Appl. No.: 17/931,048

(22) Filed: Sep. 9, 2022

(30) Foreign Application Priority Data
Sep. 10, 2021 (KR) 10-2021-0120798

(51) Int. Cl. G06T 7/55

(52) U.S. Cl. CPC G06T 7/55; G06T 2207/20084; G06T 2207/20081

(57) ABSTRACT

A depth estimation device includes a difference map generating network and a depth transformation circuit. The difference map generating network generates, from a monocular input image and using a plurality of neural networks, a plurality of difference maps corresponding to a plurality of baselines. The plurality of difference maps includes a first difference map corresponding to a first baseline and a second difference map corresponding to a second baseline. The depth transformation circuit generates a depth map using one of the plurality of difference maps.

### CROSS-REFERENCE TO RELATED APPLICATION

The present application claims priority under 35 U.S.C. § 119(a) to Korean Patent Application No. 10-2021-0120798, filed on Sep. 10, 2021, which is incorporated herein by reference in its entirety.

### BACKGROUND

### 1. Technical Field

Various embodiments generally relate to a depth estimation device and a depth estimation method using a single camera, and in particular to a depth estimation device capable, once trained, of inferring depths using only a single monocular image and a depth estimation method thereof.

### 2. Related Art

Image depth estimation technology is widely studied in the field of computer vision because of its various applications, and is a key technology for autonomous driving in particular.

Recently, depth estimation performance has been improved through self-supervised deep learning technology (sometimes referred to as unsupervised deep learning) rather than supervised learning to reduce costs. For example, a convolutional neural network (CNN) is trained to generate a disparity map that is used to reconstruct a target image from a reference image, and depth is estimated using this.

For this purpose, video streams acquired from a single camera or stereo images acquired from two cameras may be used.

In a depth estimation technique using a single camera, a neural network is trained using a video stream acquired from a single camera, and the depth is estimated using this.

However, in this method, there is a problem in that a neural network for acquiring relative pose information between adjacent frames is required and additional learning of the neural network must be performed.

Depth estimation can be performed using stereo images acquired from two cameras. In this case, training for pose estimation is not required, which makes using two cameras more efficient than using a video stream.

However, when a stereo image acquired from two cameras separated by a fixed distance is used, there is a problem that the depth estimation performance is limited due to occlusion areas. A distance between the two cameras is referred to as a baseline.

For example, when the baseline is short, the occlusion area is small and thus errors are less likely to occur, but there is a problem that the range of depth that can be determined is limited.

On the other hand, when the baseline is long, although the range of depth that can be determined increases compared to the short baseline, there is a problem that error increases due to larger occlusion areas.

In order to solve this problem, a multi-baseline camera system having various baselines can be built using a plurality of cameras, but in this case, there is a problem in that the cost of building the system is substantially increased.

### SUMMARY

In accordance with an embodiment of the present disclosure, a depth estimation device may include a difference map generating network configured to generate a plurality of difference maps corresponding to a plurality of baselines from a single input image and to generate a mask indicating a masking region; and a depth transformation circuit configured to generate a depth map by using one of the plurality of difference maps, wherein the plurality of difference maps includes a first difference map corresponding to a first baseline and a second difference map corresponding to a second baseline.

In accordance with an embodiment of the present disclosure, a depth estimation method may include receiving an input image corresponding to a single monocular image; generating, from the input image, a plurality of difference maps including a first difference map corresponding to a first baseline and a second difference map corresponding to a second baseline; and generating a depth map using one of the plurality of difference maps.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate various embodiments, and explain various principles and beneficial aspects of those embodiments.

FIG. 1 illustrates a depth estimation device according to an embodiment of the present disclosure.

FIG. 2 illustrates a set of multi-baseline images in accordance with an embodiment of the present disclosure.

FIG. 3 illustrates a difference map generating network according to an embodiment of the present disclosure.

### DETAILED DESCRIPTION

The following detailed description references the accompanying figures in describing illustrative embodiments consistent with this disclosure. The embodiments are provided for illustrative purposes and are not exhaustive. Additional embodiments not explicitly illustrated or described are possible. Further, modifications can be made to the presented embodiments within the scope of teachings of the present disclosure. The detailed description is not meant to limit embodiments of this disclosure. Rather, the scope of the present disclosure is defined in accordance with claims and equivalents thereof. Also, throughout the specification, reference to “an embodiment” or the like is not necessarily to only one embodiment, and different references to any such phrase are not necessarily to the same embodiment(s).

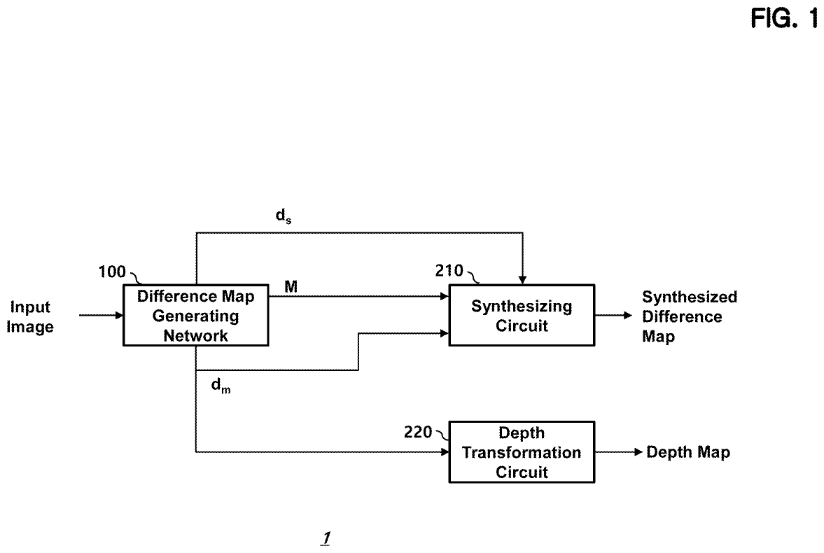

FIG. 1 illustrates a block diagram of a depth estimation device 1 according to an embodiment of the present disclosure.

The depth estimation device 1 includes a difference map generating network 100, a synthesizing circuit 210, and a depth transformation circuit 220.

During an inference operation, the difference map generating network 100 receives a single input image. The single input image may correspond to a single image taken from a monocular imaging device.

However, during a learning operation of the difference map generating network 100, a plurality of input images corresponding to sets of multi-baseline images are used. The learning operation will be disclosed in more detail below.

During the learning operation, the difference map generating network 100 generates a first difference map dₛ, a second difference map dₘ, and a mask M from the plurality of input images. During the inference operation the difference map generating network 100 may generate only the second difference map dₘ. from the single input image.

In general, a small baseline stereo system generates accurate depth information at a relatively near range. When the baseline is small, an occlusion area visible only to one of the two cameras is relatively small.

In contrast, a large baseline stereo system generates accurate depth information at a relatively far range. When the baseline is large, the occlusion area is relatively large.

The first difference map dₛ corresponds to a map indicating inferred differences between small baseline images, and the second difference map dₘ corresponds to a map indicating inferred differences between large baseline images.

Disparity represents a distance between two corresponding points in two images, and a difference map represents disparities for the entire image.

Since a technique for calculating a depth of a point using a baseline, a focal length, and a disparity is well known due to articles such as [symbol] D. Gallup, J. Frahm, P. Mordohai and M. Pollefeys, “Variable baseline/resolution stereo,” 2008 IEEE Conference on Computer Vision and Pattern Recognition, 2008, pp. 1-8, doi: 10.1109/CVPR.2008.4587671. [symbol] , a detailed description thereof will be omitted.

The difference map generating network 100 further generates a mask M, wherein the mask M indicates a masking region of the second difference map dₘ to be replaced with data of the first difference map dₛ.

A method of generating the mask M will be disclosed in detail below.

The synthesizing circuit 210 is used for a training operation, and the depth transformation circuit 220 is used for an inference operation.

The synthesizing circuit 210 applies the mask M to the second difference map dₘ, thus removing the data corresponding to the masking region from the second difference map dₘ.

The synthesizing circuit 210 generates a synthesized difference map using the first difference map dₛ and the mask M.″

In this case, the synthesizing circuit 210 replaces data of the masking region in the second difference map dₘ ″with corresponding data of the first difference map dₛ.

The depth transformation circuit 220 generates a depth map from the synthesized difference map.

In this embodiment, the first difference map dₛ corresponding to a first baseline is used inside the masking region, and the second difference map dₘ corresponding to a second baseline is used outside the masking region.

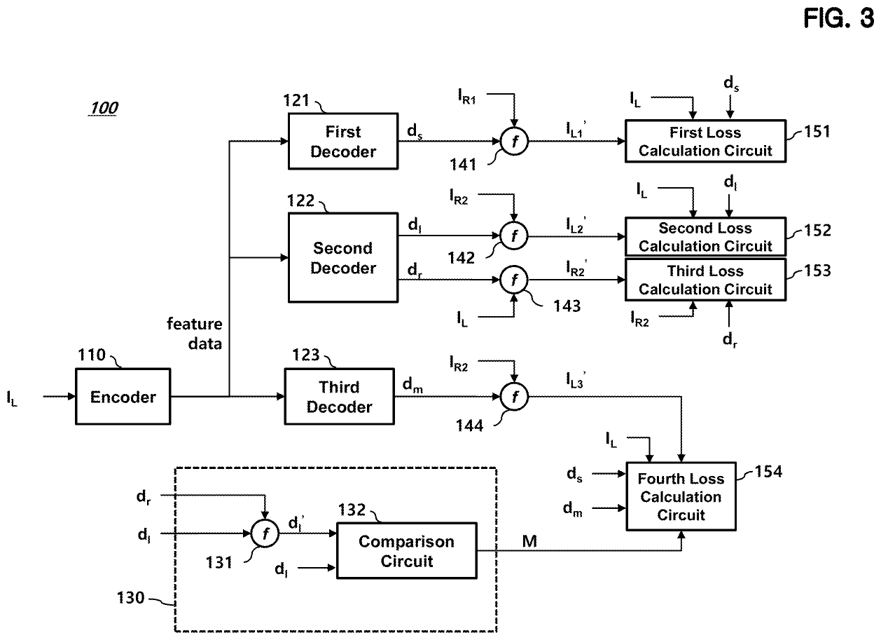

FIG. 3 illustrates the difference map generating network 100 according to an embodiment of the present disclosure.

The difference map generating network 100 includes an encoder 110, a first decoder 121, a second decoder 122, a third decoder 123, and a mask generating circuit 130.

The encoder 110 encodes an input image I_{L} to generate feature data. In embodiments, the encoder 110 uses a trained neural network to generate the feature data.

The first decoder 121 decodes the feature data to generate a first difference map dₛ, and the second decoder 122 decodes the feature data to generate a left difference map dₗ and a right difference map dᵣ, and the third decoder 123 decodes the feature data to generate a second difference is map dₘ. In embodiments, the first decoder 121, second decoder 122, and third decoder 123 use respective trained neural networks to decode the feature data.

The mask generating circuit 130 generates a mask M from the left difference map dₗ and the right difference map dᵣ.

The mask generating circuit 130 includes a transformation circuit 131 that transforms the right difference map dᵣ according to the left difference map dₗ to generate a reconstructed left difference map dₗ′.

In the present embodiment, the transformation operation corresponds to a warp operation, and the warp operation is a type of transformation operation that transforms a geometric shape of an image.

In this embodiment, the transformation circuit 131 performs a warp operation as shown in Equation 1. The warp operation by the Equation 1 is known by prior articles such as [symbol] Saad Imran, Sikander Bin Mukarram, Muhammad Umar Karim Khan, and Chong-Min Kyung, “Unsupervised deep learning for depth estimation with offset pixels,” Opt. Express 28, 8619-8639 (2020) [symbol] . Equation 1 represents a warp function f_{w} used to warp an image I with the difference map d. In detail, warping is used to change the viewpoint of a given scene across two views with a given disparity map. For example, if IL is a left image and dR is a difference map between the left image IL and a right image IR with the right image IR taken as reference, then in the absence of occlusion, fw(IL; dR) should be equal to the right image IR.

f_{w}(I; d)=I(i+dₗ(i, j), j)∀i, j [Equation 1]

The transformation circuit 131 may additionally perform a bilinear interpolation operation as described in [symbol] M. Jaderberg, K. Simonyan, A. Zisserman, and K. Kavukcuoglu, “Spatial transformer networks,” in Advances in neural information processing systems, (2015), pp. 2017-2025 [symbol] on the operation result of Equation 1.

The mask generating circuit 130 includes a comparison circuit 132 that generates the mask M by comparing the reconstructed left difference map dₗ′ with the left difference map dₗ.

In the occlusion region, there is a high probability that the reconstructed left difference map dₗ′ and the left difference map di have different values.

Accordingly, in the present embodiment, if a difference between each pixel of the reconstructed left difference map dₗ′ and the corresponding pixel of the left difference map dₗ is greater than a threshold value, which is 1 in an embodiment, then corresponding mask data for that pixel is set to 1. Otherwise, the corresponding mask data for that pixel is set to 0. Hereinafter, an occlusion region may be referred to as a masking region.

During the inference operation, the input image I_{L} is one monocular image such as may be acquired by a single camera. During the inference operation the encoder 110 generates the feature data from the single input image I_{L} and the third decoder 123 generates the second difference map dₘ from the feature data.

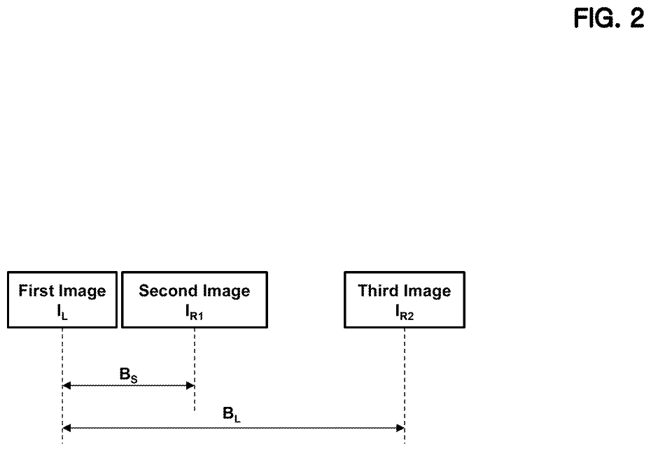

During the learning operation, a prepared training data set is used and the training data set includes three images as one unit of data as shown in FIG. 2.

The three images include a first image I_{L}, a second image I_{R1}, and a third image I_{R2}.

The first image I_{L} corresponds to a leftmost image, the second image I_{R1} corresponds to a middle image, and the third image I_{R2} corresponds to a rightmost image.

That is, the first image I_{L} and the second image I_{R1} correspond to a small baseline Bₛ image pair, and the first image I_{L} and the third image I_{R2} correspond to a large baseline B_{L} image pair.

During the learning operation, the total loss function is calculated and weights included in the neural networks of the encoder 110, the first decoder 121, and the second decoder 122 shown in FIG. 3 are adjusted according to the total loss function.

In this embodiment, weights for the third decoder 123 are adjusted separately, as will be described in detail below.

In this embodiment, the total loss function Lₜₒₜₐₗ corresponds to a combination of an image reconstruction loss component L_{recon}, a smoothness loss component Lₛₘₒₒₜₕ, and a decoder loss component L_{dec3}, as shown in Equation 2.

Lₜₒₜₐₗ=L_{recon}+λLₛₘₒₒₜₕ+L_{dec3} [Equation 2]

In Equation 2, a smoothness weight λ is set in embodiments to 0.1.

In Equation 2, the image reconstruction loss component L_{recon} is defined as Equation 3.

L_{recon}=Lₐ(I_{L}, I_{L1}′)+Lₐ(I_{L}, I_{L2}′)+Lₐ(I_{R2}, I_{R2}′) [Equation 3]

In Equation 3, the reconstruction loss component L_{recon} is expressed as the sum of the first image reconstruction loss function Lₐ between the first image I_{L} and the first reconstruction image I_{L1}′, the second reconstruction loss function Lₐ between the first image I_{L} and the second reconstruction image I_{L2}′, and the third image reconstruction loss function Lₐ between the third image I_{R2} and the third reconstruction image I_{R2}′.

In FIG. 3, the first loss calculation circuit 151 calculates a first image reconstruction loss function, the second loss calculation circuit 152 calculates a second image reconstruction loss function, and the third loss calculation circuit 153 calculates a third image reconstruction loss function.

The transformation circuit 141 transforms the second image I_{R1} according to the first difference map dₛ to generate a first reconstructed image I_{L1}′.

The transformation circuit 142 transforms the third image I_{R2} according to the left difference map dₗ to generate a second reconstructed image I_{L2}′.

The transformation circuit 143 transforms the first image I_{L} according to the right difference map dᵣ to generate a third reconstructed image I_{R2}′.

The image reconstruction loss function Lₐ is expressed by Equation 4. The image reconstruction loss function Lₐ of Equation 4 represents photometric error between an original image I and a reconstructed image I′.

$${L}_{a} ( I , {I}^{′} ) = \frac{1}{N} \sum ( α \frac{1 - SSIM ( {I}_{ij} , {I}_{ij}^{′} )}{2} + ( 1 - α ) \vert {I}_{ij} - {I}_{ij}^{′} \vert ) \qquad [ Equation 4 ]$$

In Equation 4, the Structural Similarity Index (SSIM) function is used for comparing similarity between images and a well-known function through an article such as [symbol] Zhou Wang, Alan C Bovik, Hamid R Sheikh, and Eero P Simoncelli. Image quality assessment: from error visibility to structural similarity. IEEE transactions on image processing, 13(4):600?612, 2004. [symbol] .

In Equation 4, N denotes the number of pixels, I denotes an original image, and I′ denotes a reconstructed image. In this embodiment, a 3×3 block filter is used instead of a Gaussian for the SSIM operation.

In this embodiment, the value of alpha is set to 0.85, so that more weight is given to the SSIM calculation result. The SSIM calculation result produces values based on contrast, illuminance, and structure.

When the difference in illuminance between the two images is large, it may be more effective to use the SSIM calculation result.

In Equation 2, the smoothness loss component Lₛₘₒₒₜₕ is defined by Equation 5. The smoothness loss discourages disparity smoothness in absence of small image gradients.

Lₛₘₒₒₜₕ=Lₛ(dₛ, I_{L})+Lₛ(dₗ, I_{L})+Lₛ(dᵣ, I_{R2}) [Equation 5]

In Equation 5, the smoothness loss component Lₛₘₒₒₜₕ is expressed as the sum of the first smoothness loss function Lₛ between the first difference map dₛ and the first image I_{L}, the second smoothness loss function Lₛ between the left difference map di and the first image I_{L}, and the third smoothness loss function Lₛ between the right difference map dᵣ and the third image I_{R2}.

In FIG. 3, the first loss calculation circuit 151 calculates the first smoothness loss function, the second loss calculation circuit 152 calculates the second smoothness loss function, and the third loss calculation circuit 153 calculates the third smoothness loss function.

The smoothness loss function Lₛ is expressed by the following Equation 6. In Equation 6, d corresponds to an input difference map, I corresponds to an input image, ∂x is a horizontal gradient of the input image, and ∂y is a vertical gradient of the input image. It can be seen from Equation 6 that when the image gradient is small, the smoothness loss component becomes small. This same loss has been used in the articles such as [symbol] Godard, Clément et al. “Unsupervised Monocular Depth Estimation with Left-Right Consistency.” 2017 IEEE Conference on Computer Vision and Pattern Recognition (CVPR) (2017): 6602-6611 [symbol] .

$${L}_{s} ( d , I ) = \frac{1}{N} {\sum }_{i , j} ( \vert {\partial }_{x} {d}_{ij} \vert {e}^{- \vert {\partial }_{x} {I}_{ij} \vert} + \vert {\partial }_{y} {d}_{ij} \vert {e}^{- \vert {\partial }_{y} {I}_{ij} \vert} ) \qquad [ Equation 6 ]$$

In Equation 2, the decoder loss component L_{dec3} is defined by Equation 7. Here, the decoder loss component is associated with the third decoder 123.

L_{dec3}=(1−M)·Lₐ(I_{L}, I_{L3}′)+L_{da}(dₛ, dₘ)+λ·Lₛ(dₘ, I_{L}) [Equation 7]

In Equation 7, the decoder loss component L_{dec3} is expressed as sum of the fourth image reconstruction loss function Lₐ between the first image I_{L} and the fourth reconstruction image I_{L3}′, the fourth smoothness loss function Lₛ between the second difference map dₘ and the first image I_{L}, and the difference assignment loss function L_{da} between the first difference map dₛ and the second difference map dₘ.

In FIG. 3, the fourth loss calculation circuit 154 calculates the fourth image reconstruction loss function Lₐ, the fourth smoothness loss function Lₛ, and the difference assignment loss function L_{da}.

The calculation method of the fourth image reconstruction loss function Lₐ and the fourth smoothness loss function Lₛ is the same as described above.

The transformation circuit 144 transforms the third image I_{R2} according to the second difference map dₘ to generate a fourth reconstructed image I_{L3}′.

In Equation 7, (1−M) indicates that pixels in the masking region (also referred to as the occlusion region) do not affect the image reconstruction loss, and the difference allocation loss L_{da} is considered in the masking region.

In order for the second difference map dₘ to follow the first difference map dₛ in the masking region, that is, to minimize the value of the difference assignment loss function L_{da}, only the weights of the third decoder 123 are adjusted. Accordingly, the first difference map dₛ is not affected by the difference assignment loss function L_{da}.

In Equation 7, the difference assignment loss function L_{da} is defined by Equation 8.

$${L}_{da} ( {d}_{s} , {d}_{m} ) = M \cdot \frac{1}{N} {\sum }_{i , j} ( β \frac{1 - SSIM ( r \cdot {d}_{s} , {d}_{m} )}{2} + ( 1 - β ) \vert r \cdot {d}_{s} - {d}_{m} \vert ) \qquad [ Equation 8 ]$$

In this embodiment, β is set to 0.85, and r is the ratio of the large baseline to the small baseline.

By using r, the scale of the first difference map dₛ can be adjusted to the scale of the second difference map dₘ. For example, when the small baseline is 1 mm and the large baseline is 5 mm, the difference range of the second difference map dₘ is 5 times the difference range of the first difference map dₛ, and the ratio r is set to 5.

Although various embodiments have been illustrated and described, various changes and modifications may be made to the described embodiments without departing from the spirit and scope of the invention as defined by the following claims.

What is claimed is:

1. A depth estimation device comprising:
a difference map generating network configured to generate a plurality of difference maps corresponding to a plurality of baselines from a single input image and to generate a mask indicating a masking region; and
a depth transformation circuit configured to generate a depth map using one of the plurality of difference maps,
wherein the plurality of difference maps includes a first difference map corresponding to a first baseline and a second difference map corresponding to a second baseline.

2. The depth estimation device of claim 1, further comprising
a synthesizing circuit configured to generate a synthesized difference map by combining the mask, the first difference map, and the second difference map.

3. The depth estimation device of claim 2, wherein the synthesizing circuit generates the synthesized difference map by synthesizing data of the first difference map corresponding to the masking region with the second difference map.

4. The depth estimation device of claim 1, wherein the difference map generating network comprises:
an encoder configured to generate, using a first neural network, feature data by encoding the input image;
a first decoder configured to generate, using a second neural network, the first difference map from the feature data;
a second decoder configured to generate, using a third neural network, a left difference map and a right difference map from the feature data;
a third decoder configured to generate, using a fourth neural network, the second difference map from the feature data; and
a mask generating circuit configured to generate the mask according to the left difference map and the right difference map.

5. The depth estimation device of claim 4, wherein the mask generating circuit comprises:
a transformation circuit configured to generate a reconstructed left difference map by transforming the right difference map according to the left difference map; and
a comparison circuit configured to generate the mask according to the left difference map and the reconstructed left difference map.

6. The depth estimation device of claim 5, wherein the comparison circuit determines data of the mask by comparing a threshold value with a difference between the left difference map and the reconstructed left difference map.

7. The depth estimation device of claim 4, wherein a learning operation for the second, third, and fourth neural networks uses a first image, a second image paired with the first image to form a first baseline image pair, and a third image paired with the first image to form a second baseline image pair.

8. The depth estimation device of claim 7, further comprising a first loss calculation circuit to calculate a first loss function by using the first image and a first reconstructed image generated by transforming the second image according to the first difference map.

9. The depth estimation device of claim 7, further comprising:
a second loss calculation circuit configured to calculate a second loss function by using the first image and a second reconstructed image generated by transforming the third image according to the left difference map; and
a third loss calculation circuit configured to calculate a third loss function by using the third image and a third reconstructed image generated by transforming the first image according to the right difference map.

10. The depth estimation device of claim 7, further comprising a fourth loss calculation circuit configured to calculate a fourth loss function by calculating a first loss subfunction using the first image and a fourth reconstructed image generated by transforming the third image according to the second difference map, calculating a second loss subfunction using the first difference map and the second difference map, and calculating a third loss subfunction by using the second difference map and the first image.

11. A depth estimation method comprising:
receiving an input image corresponding to a single monocular image;
generating, from the input image, a plurality of difference maps including a first difference map corresponding to a first baseline and a second difference map corresponding to a second baseline;
generating a depth map using one of the plurality of difference maps.

12. The depth estimation method of claim 11, further comprising:
generating, from the input image, a mask indicating a masking region; and
generating a synthesized difference map by combining the mask, the second difference map and the first difference map.

13. The depth estimation method of claim 12,
wherein generating the synthesized difference map comprises synthesizing data of the first difference map corresponding to the masking region with the second difference map.

14. The depth estimation method of claim 11, further comprising:
generating feature data by encoding the input image using a first neural network,
wherein generating the plurality of difference maps comprises:
generating the first difference map by decoding the feature data using a second neural network; and
generating the second difference map by decoding the feature data using a fourth neural network
wherein generating the mask comprises:
generating a left difference map and a right difference map by decoding the feature data using a third neural network, and
generating the mask according to the left difference map and the right difference map.

15. The depth estimation method of claim 14, wherein generating the mask comprises:
generating a reconstructed left difference map by transforming the right difference map according to the left difference map; and
generating the mask by comparing a threshold value to a difference between the left difference map and the reconstructed left difference map.

16. The depth estimation method of claim 14, wherein a learning operation for the one or more of the first through fourth neural networks uses a first image, a second image paired with the first image to form a first baseline image pair, and a third image paired with the first image to form a second baseline image pair.

17. The depth estimation method of claim 16, wherein the learning operation comprises:
calculating a first loss function by using the first image and a first reconstructed image generated by transforming the second image according to the first difference map;
calculating a second loss function by using the first image and a second reconstructed image generated by transforming the third image according to the left difference map;
calculating a third loss function by using the third image and a third reconstructed image generated by transforming the first image according to the right difference map;
training the first, second, and third neural networks using the first, second, and third loss functions;
calculating a fourth loss function by calculating a first loss subfunction using the first image and a fourth reconstructed image generated by transforming the third image according to the second difference map, calculating a second loss subfunction using the first difference map and the second difference map, and calculating a third loss subfunction by using the second difference map and the first image; and
training the fourth neural networks using the fourth loss function.
